(19) United States
(12) Patent Application Publication
(10) Pub. No.: US 2025/0382446 A1
(43) Pub. Date: Dec. 18, 2025

(54) NBR AND ETHYLENE BLEND

(71) Applicant: GATES CORPORATION, Denver, CO (US)

(72) Inventors: Thomas S. Moss, III, Denver, CO (US); Mathew Thomas, Lalru Punjab (IN); Charles F. Ochoa, Columbia, MO (US); Dipanjan Das, Lalru Punjab (IN)

(73) Assignee: GATES CORPORATION, Denver, CO (US)

(21) Appl. No.: 18/879,873

(22) PCT Filed: Jun. 28, 2023
(86) PCT No.: PCT/US2023/026424

§ 371 Date: Dec. 30, 2024

Related U.S. Application Data
(60) Provisional application No. 63/356,591, filed on Jun. 29, 2022.

(51) Int. Cl. C08L 9/02; F16G 1/28

(52) U.S. Cl. CPC C08L 9/02; F16G 1/28; C08L 2205/025; C08L 2205/03; C08L 2207/324

(57) ABSTRACT

A rubber composition having a polymer blend of nitrile and ethylene terpolymers, particularly acrylonitrile-butadiene copolymer (NBR) and ethylene polymers. The composition has NBR as 30-50 wt.-% of the total composition. In some embodiments, the ethylene polymer is EPDM rubber, an ethylene acrylic elastomer, or a chlorinated polyethylene. The composition can include an organic peroxide or other accelerator. The rubber composition is useful for synchronous belts having moderate to high temperature resistance, good fuel resistance, flexibility down to −40° C. and high structural integrity. Additionally, the rubber composition allows reduction in the amount of reinforcing material such as carbon black.

### TECHNICAL FIELD

The present application relates to compositions, particularly, rubber compositions, for use in flexible belts, such as synchronous belts having moderate to high temperature resistance, good oil resistance, flexibility down to −40° C. and high structural integrity.

### BACKGROUND

HNBR, a hydrogenated version of NBR rubber, is a synthetic rubber with very good temperature resistance and excellent oil resistance and which is widely used in synchronous belt compounds to meet application requirements.

Alternative materials are desired, which meet synchronous belt application requirements, including temperature resistance and oil resistance.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to a rubber composition having a polymer blend of nitrile and ethylene terpolymers, particularly, a composition with an acrylonitrile-butadiene copolymer (NBR) and ethylene polymers. The composition has NBR as 30-50 wt.-% of the total composition. In some embodiments, the ethylene polymer is EPDM rubber (which is a well-known rubber made from ethylene, propylene, and a diene comonomer that enables crosslinking via sulfur vulcanization). In other embodiments, the ethylene polymer is an ethylene acrylic elastomer. In yet other embodiments, the ethylene polymer is a chlorinated polyethylene. The composition can include an organic peroxide or other accelerator.

The rubber composition is useful for synchronous belts having moderate to high temperature resistance, good oil resistance, flexibility down to −40° C. and high structural integrity. Additionally, the rubber composition allows reduction in the amount of reinforcing material such as carbon black while maintaining the required properties for synchronous belts.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1A is the chemical structure of acrylonitrile butadiene rubber (NBR); FIG. 1B is a qualitative mapping of mechanical properties of NBR.

FIG. 2A is the chemical structure of EPDM with ethylidene norbornene (ENB) as a non-conjugated diene; FIG. 2B is a qualitative mapping of mechanical properties of EPDM.

FIG. 3 is a qualitative mapping of mechanical properties of NBR/EPDM blend.

FIG. 4 is a qualitative mapping of mechanical properties of HNBR.

FIG. 5 is a perspective view of an example belt made with a composition of the present disclosure.

### DETAILED DESCRIPTION

As indicated, the present disclosure is directed to a rubber composition having a polymer blend of nitrile and ethylene polymers, particularly, the composition has acrylonitrile-butadiene copolymer (NBR) and an ethylene polymer, where the NBR can be 30 to 50 wt.-% of the total blend and the ethylene polymer can be 20 to 40 wt.-% of the total blend, with the remainder being ingredients such as activators, fillers, curing agents, reinforcing materials, antidegradants (e.g., antioxidants, UV stabilizers), plasticizers, antistatic agents, colorants, processing aids, homogenizers, coagents, catalysts, and the like.

The base polymers of the composition have abundant availability. The composition can be organic peroxide cured or accelerator cured. The cured composition can have a minimum Mooney viscosity less than 60MU when tested at 133° C. This composition has a superior adhesion strength, with a tensile strength more than 18 MPa and temperature resistance up to 135° C. with retention of physical properties. The cured composition has a volume swell below 20% in IRM 901 oil at 135° C. for 168 hours; hence the composition has good oil resistant at high temperature. Additionally, the cured composition remains flexible at −35° C.

In the following description, reference is made to the accompanying drawing that forms a part hereof and in which is shown by way of illustration at least one specific implementation. The following description provides additional specific implementations. These embodiments are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

The present disclosure is directed to a rubber composition having a polymer blend of nitrile and ethylene polymers, particularly, acrylonitrile-butadiene copolymer (NBR) and an ethylene polymer. Examples of suitable ethylene polymers include EPDM rubber (which is a well-known rubber made from ethylene, propylene, and a diene comonomer that enables crosslinking via sulfur vulcanization), ethylene acrylic polymers or elastomers, and chlorinated polyethylene polymers. The composition has NBR as 30-50 wt.-% of the total composition. In some embodiments, the composition includes an organic peroxide or other accelerator to add in curing. Also in some embodiments, the composition includes a non-conjugated diene, at less than 15 wt.-% of the ethylene polymer weight.

The rubber composition is well suited for use in synchronous belts for automotive and industrial applications, as the cured composition has moderate to high temperature resistance, good oil resistance, flexibility down to −40° C. and high structural integrity.

As indicated, the composition includes a blend of acrylonitrile-butadiene copolymer (NBR) and an ethylene polymer, and optionally, a third monomer, a non-conjugated diene, at less than 15% of the ethylene polymer weight.

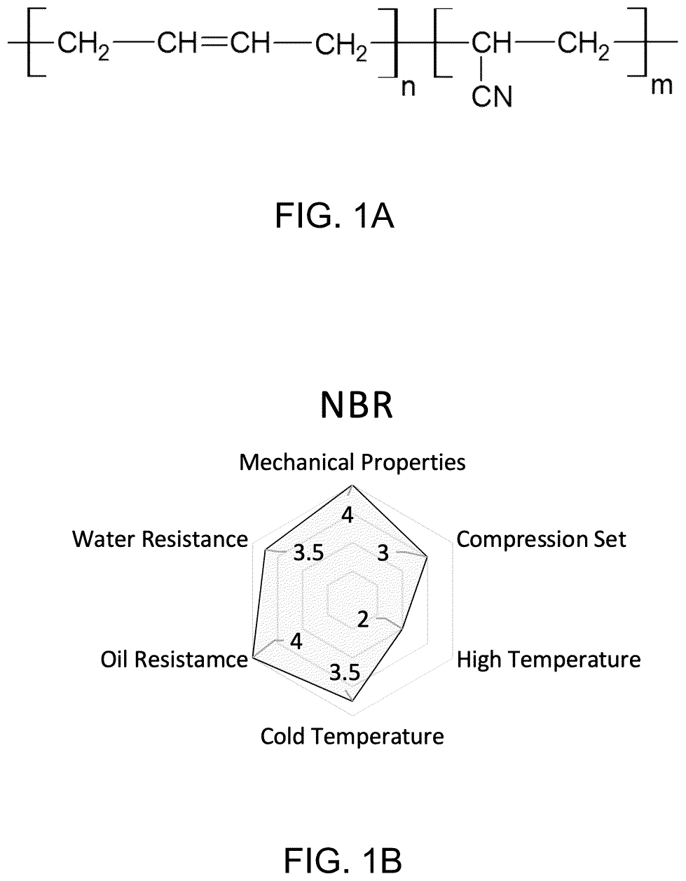

FIG. 1A shows the chemical structure of acrylonitrile butadiene rubber (NBR), and FIG. 1B is a qualitative mapping of mechanical properties of NBR. NBR has excellent mechanical properties, water resistance, oil resistance, and solvent resistance. NBR has excellent cold temperature resistance, but not high temperature resistance, however, the presence of unsaturation on the polymer backbone results in a poor ozone and heat ageing properties. Therefore, blending NBR with other polymers can improve the temperature resistance and ozone resistance.

The blend of NBR and the ethylene polymer provides a composition that has better qualities than either material. For example, a composition of NBR and EPDM provides better properties than either polymer alone.

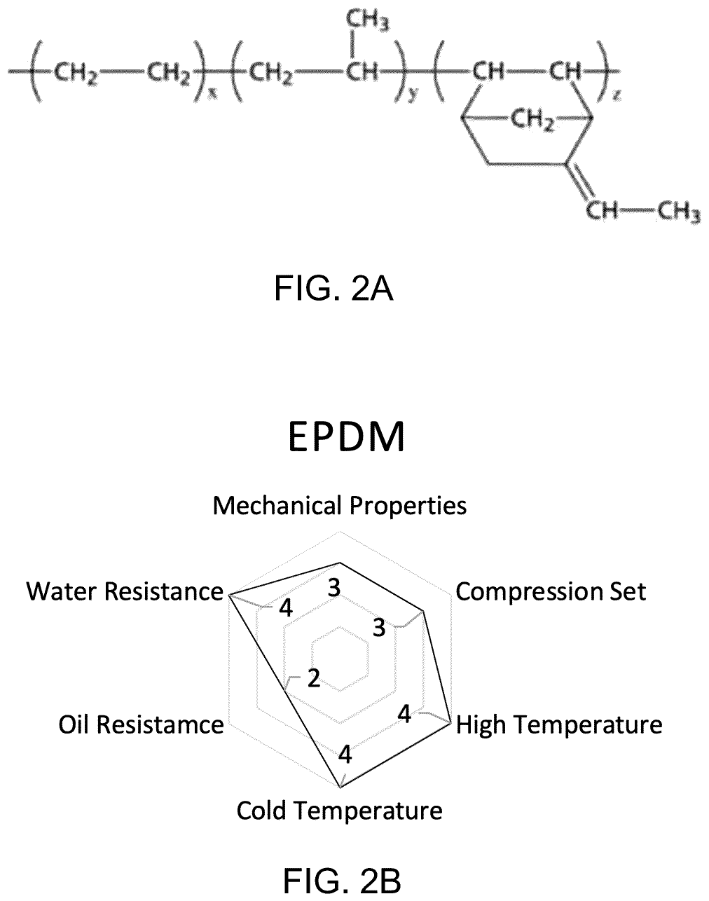

FIG. 2A shows the chemical structure of EPDM with ethylidene norbornene (ENB) as a non-conjugated diene, and FIG. 2B is a qualitative mapping of mechanical properties of EPDM. EPDM has excellent temperature resistance, for both cold and high temperatures and good water resistance, but poor oil and solvent resistance, even in its cured state. EPDM also has good heat ageing and ozone properties.

The blend of NBR and EPDM is unexpected, as it is well known that NBR and EPDM do not have good compatibility. NBR is a polar polymer due to the presence of the acrylonitrile group whereas EPDM is a non-polar rubber. However, the presence of non-conjugated diene in the EPDM increases the compatibility of the two polymers by inducing some polarity in the ethylene propylene chain. Both the acrylonitrile content in NBR and diene content in EPDM together facilitate good compatibility between the polymers. The composition blend has high tensile, elongation and tear properties, which indicate an improved compatibility between the polymers.

The resulting blended composition of NBR and EPDM has the desirable balance of temperature resistance and ageing, ozone resistance, and solvent resistance. The composition is also sufficient flexibility at temperatures as low as −40° C., which is a general requirement for synchronous belts for automotive and industrial applications. The composition also exhibits excellent adhesion when compounded with selected bonding agents.

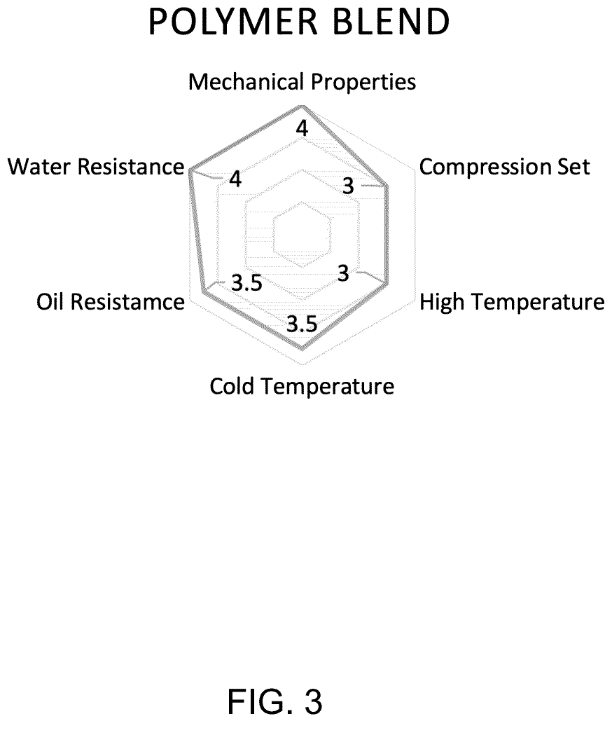

FIG. 3 is a qualitative mapping of mechanical properties of an NBR/EPDM blend. It is seen that generally all the properties of the blend are improved over the properties of the two polymers alone. The blended composition has excellent mechanical properties, and water and oil resistance. The composition has good temperature resistance, for both cold and high temperature.

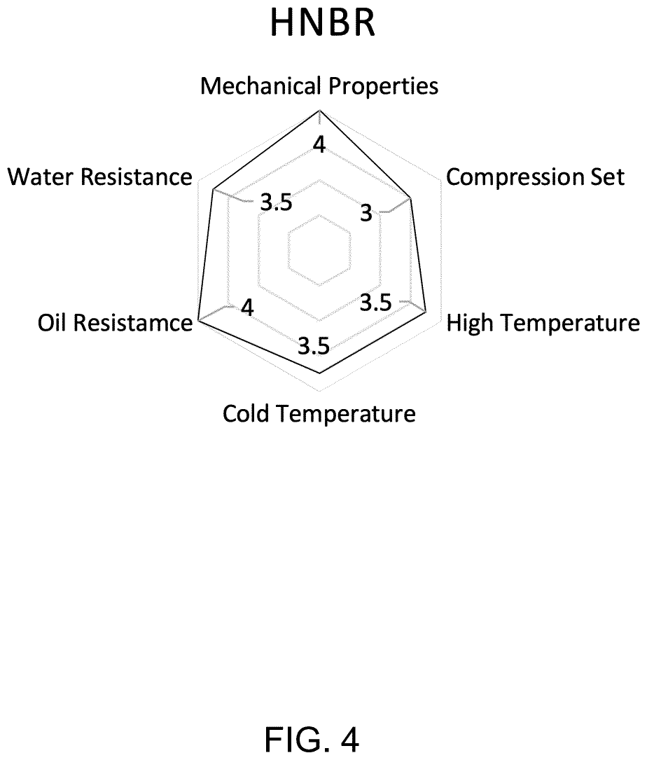

FIG. 4 is a qualitative mapping of mechanical properties of HNBR, for which the NBR and ethylene polymer blend is a replacement. It is seen that the properties of the blended composition are comparable or close to the properties of HNBR.

Other ethylene polymers suitable for blending with NBR include ethylene acrylic elastomer, chlorinated polyethylene, ethylene propylene elastomer (EPM), ethylene butene (EBM), ethylene pentene and ethylene octene (EOM).

The selection of polymer grade affects the blended compound flow characteristics. High molecular grades, having higher Mooney viscosity, are not desirable for synchronous belts for automotive application due to poor flow and hence poor belt tooth formation, but the final cured material (e.g., the vulcanizate) has a superior physical property such as tensile strength, modulus and elongation. On the other hand, low molecular weight grades promote flow but the blended vulcanizate may not possess sufficient physical strength. There are many commercially available NBR grades with different molecular weights (e.g., Mw and Mn). These can be characterized by the Mooney viscosity (ML 1+4 at 100° C.) of the polymer which ranges from 30 to 90 MU.

NBR polymer typically is about 20 to about 50 wt.-% acrylonitrile. The presence of the acrylonitrile group provides good solvent resistance to NBR and this property can be further enhanced by selecting a higher acrylonitrile containing NBR. However, the acrylonitrile group reduces the cold flexibility of the NBR and the blended composition. For example, NBR with 34% acrylonitrile content has a glass transition temperature close to −35° C. As the acrylonitrile content increases, so does the glass transition temperature, resulting in reduced cold flexibility of both the NBR and the blended composition.

The amount of NBR and ethylene polymer is from 25 wt.-% to 75 wt.-% of the total weight of the raw ingredients that form the uncured blended composition, with the NBR being 30 to 60 wt.-% of the total and the ethylene polymer being 10 to 30 wt.-% of the total. In some embodiments, the NBR and the ethylene is from about 40 wt % to 70 wt % of the total weight of the raw ingredients, in other embodiments about 45-60 wt %.

The weight ratio of the NBR and the ethylene is from 3:1 to 1:1; in some embodiments, the NBR and the ethylene are present at a weight ratio of about 2:1.

Examples of suitable ethylene polymers for blending with NBR include EPDM, ethylene propylene elastomer (EPM), ethylene acrylic elastomer, chlorinated polyethylene, ethylene butene (EBM), ethylene pentene and ethylene octene (EOM).

EPDM is a terpolymer of ethylene and propylene with a saturated polymer backbone and a saturated non-conjugated diene monomer as well as ethylene-propylene copolymer. Examples of diene monomers present in EPDM are dicyclopentadiene (DCPD), ethylidene norbornene (ENB), 1,4 hexadiene and methylidene norbornene.

EPDM is typically about 30% to about 80 wt.-% ethylene and about 0% to about 15% non-conjugated diene. Typically, the diene content can be identified by iodine numbers of about 5 to about 30. The Mooney viscosity (ML1+4 at 125° C.) is typically about 40 to about 100 MU. Above 70 wt.-% ethylene, the EPDM polymer exhibits crystalline characteristics.

In addition to the NBR and the ethylene polymer, the blended composition may include additional rubber stock including, but not limited to, any of natural rubber, styrene-butadiene rubber (SBR), chloroprene rubber (CR), hydrogenated nitrile butadiene rubber (HNBR), and fluoroclastomers (FKM).

The rubber stock (NBR, EPDM, and any other) is often in the form of a solid powder, pellet, bale or block, although in some embodiments may be a liquid or semi-liquid.

As indicated above, the blended composition can include an organic peroxide or other accelerator to facilitate curing of the blended composition. Various type of organic peroxides can be used with the blended composition. Organic peroxides undergo decomposition at a certain temperature and produces radicals that initiate the cross-linking reaction in the compound. One particular example of an organic peroxide for use with NBR and EPDM is a,a-bis (t-butylperoxy) diisopropyl-benzene. In some embodiments, the total amount of organic peroxide is less than about 2.5 wt.-% of the raw ingredients.

Polymer compositions cured with organic peroxides exhibit higher thermal resistance due to the formation of C—C cross links between the polymer chain. In contrast, sulfur cured polymers form C—S—C or C—(S) x-C bonds. Formation of mono sulfidic (i.e., C—S) bonds or poly sulfidic bonds (i.e., S—S) bonds leads to inferior thermal resistance of the polymer. The C—C bond energy (346 k J/mol) is higher than both C—S(272 k J/mol) and S—S(226 k J/mol) bond energy; this reflects in the higher temperature resistance of peroxide cured vulcanizate.

The blended composition can include various additives such as activators, fillers, curing agents, reinforcing materials, antidegradants (e.g., antioxidants, UV stabilizers), plasticizers, antistatic agents, colorants, processing aids, homogenizers, coagents, catalysts, and the like. Generally, the total wt.-% of additives is less than 65 wt.-% of the raw ingredients of the total composition, in some embodiments less than 50 wt.-%.

Examples of activators include stearic acid and zinc oxide. Stearic acid is commonly a solid, available as flakes or pellets, with a specific gravity of about 0.85. Stearic acid includes an amount of iodine, typically no more than 10 wt.-%. The acid value ranges between 193 and 213. Zinc oxide is also a solid, e.g., a fine powder with a surface area of 4-6 m2/g, with a specific gravity of 5.6. Zinc oxide may have some impurities present therein; e.g., CuO <0.0005 wt.-%, MnO<0.0005 wt.-%, SiO2<0.02 wt.-% and/or water soluble salts<0.05 wt.-%. In some embodiments, the total amount of activator(s) is less than about 5 wt.-% of the raw ingredients, in some embodiments less than about 3 wt.-%. Long chain fatty (LCF) acids can be used as a homogenizer, and when combined with zinc oxide, can act as an activator.

Any suitable curing agent(s) or material can be used, with the agent facilitating or assisting during curing. Example curing agent(s) suitable include sulfur and peroxides. In some embodiments, the amount of curative used is less than about 8 wt.-% of the total weight of the raw ingredients, such as less than 5 wt.-%.

Silica may be added to provide greater tensile strength, higher modulus, reduced compression set, and increased abrasion resistance to the blended composition. Silica is typically a solid, e.g., powder, and may be treated or untreated. The surface area of silica is typically between 120-200 m²/g. An example treated silica, having 5-8 wt.-% organosilane treatment, has a specific gravity of 1.9-2.0. This example silica has a volatile content of 3-5%, and a pH value between 6-8. The organosilane is a trialkoxysilane type. Because of this, the treated silica material has low moisture absorption and significantly low volatile formation during mixing and processing. In some embodiments, the total amount of silica is about 10 to 35 wt.-% of the raw ingredients.

Carbon black and/or graphite can be used as a filler in rubber compounds. Examples of other fillers include metal oxides such as aluminum oxide, magnesium oxide, copper oxide, and zinc oxide, clay, montorillonite clay, pulp, and mica.

The raw materials of the blended composition may include reinforcement material, such as chopped fiber segments, though other reinforcement material such as elongated segments, fibers, or nanotubes, can also be used. The reinforcement material, whether chopped or elongate, may be, e.g., aramid, polyester (PET), cotton, nylon, glass, carbon fiber cords, hybrid cords, metal, ceramic, and other plastic. The reinforcement material may be made from either organic or synthetic material, or a mixture of organic and synthetic materials.

The dimensions of the reinforcement material are generally not limited. In some embodiments, the chopped fibers have a high aspect ratio having a length in the range of from 0.2 mm to 3 mm. In some embodiments, the reinforcement materials (e.g., chopped fibers or elongate materials) have an aspect ratio of from 10 to 250. In some embodiments, the amount of reinforcement material is from 5 wt.-% to 30 wt.-% of the total weight of the raw ingredients. The reinforcement material is mixed with the raw ingredients and the resulting belt has the reinforcement materials homogeneously dispersed throughout the blended composition.

In some embodiments, the amount of filler (including any silica, carbon black or carbon reinforcing fibers) is from 5 wt.-% to 45 wt.-% of the total weight of the raw ingredients, whereas in other embodiments the filler is from about 10 wt.-% to about 20 wt.-% of the total weight of the raw ingredients. The polymer blend of NBR and ethylene polymer allows a decrease in the amount of carbon reinforcing fibers or other carbon and increase in other fillers, while still obtaining acceptable properties for synchronous belts. In some embodiments, the ratio of silica to reinforcing carbon is 5:1 to 3:1, for example, about 4:1.

Polymers are subject to degradation when exposed to different types of environmental factors, factors including oxygen, heat/temperature, UV light, weathering, catalytic degradation due to heavy metal ions, dynamic fatigue, etc. The failures observed in rubber compounds due to environmental degradation include loss of elasticity and tensile strength, formation of crazed surface, and appearance of cracks. The presence of unsaturation in a polymer can increase the tendency of failure due to heat ageing, due to the allylic C—H bond in an unsaturated chemical structure. The bond energy of allylic C—H is weakest among different type (primary, secondary, tertiary) of C—H bonds. This factor promotes the formation of free radicals and peroxy radicals in the presence of oxygen and heat and causes chain scission. Once the polymer main chain is broken, the compound starts to lose its physical and mechanical strength and starts to degrade. Antioxidants acts as a radical trap; they scavenge radicals to stop polymer chain scission and enhance the service life of the resulting product.

An antioxidant that can be used in rubber compounds, especially with NBR, NR, BR and SBR compounds, is a polymerized quinoline derivative, 1,2-dihydro-2,2,4-tri-methylquinoline. Another antioxidant is a condensate of alkylated imidazole and diarylamine or ketone, and another is a condensate of mercaptobenzimidazole and diphenyleamine/acetone; these are strong non staining antioxidants for natural and synthetic rubber and offer extremely good temperature and flex protection at elevated temperatures.

Plasticizers can be added to elastomeric compounds for various reasons, such as increasing softness or flexibility, lowering the glass transition temperature, reducing crystallization, increasing dispersion, or lowering the cost of the compound. Common plasticizers used in elastomer compounds are mineral oils and esters such as phthalates, sebacates, and adipates. NBR is compatible with various type of ester plasticizers including adipates, phthalates, trimellitates.

Di-alkyl ester and di octyl adipate (DOA) are highly efficient plasticizers that can be used to impart excellent low temperature flexibility and resistance to impact to the compound. In addition to their high efficiency and contribution to the low temperature properties, they are chemically stable and resistant to discoloration on extended exposure to temperature and ultraviolet light. The combination of low viscosity and efficiency provide excellent dry blending and processing characteristics.

Microcrystalline wax can be added as a physical antiozonant for unsaturated rubber. The polymer chains containing double bonds are vulnerable to ozonolysis reaction and chain scission when in the presence of ozone. Microcrystalline wax provides a shielding layer or barrier over the compound and protects it from degradation because of chain scission.

Modified resorcinol, which is a resorcinol formaldehyde homopolymer resin modified with a selected group, can be used as a precondensed dry bonding agent; chemically, it is a resorcinol formaldehyde homopolymer resin modified with a selected group. Modified resorcinol facilitates the homogeneity of the blended composition.

Metallic acrylates such as zinc dimethacrylate can be used to boost the physical and mechanical properties of the compound and acts as a coagent. In the presence of organic peroxide, metallic coagents form ionic bonds and improves tear strength, modulus, and flex resistance of the compound.

Modified polybutadiene (with maleic anhydride) can be used as a bonding promoter in peroxide cured vulcanizates. Chemically, it is a low molecular weight, low vinyl butadiene functionalized with maleic anhydride. The anhydride functionality can react with epoxy, amine, and hydroxyl groups, enabling the creation of unique adhesives, sealants, encapsulants, and coatings. It also improves compatibility of the non-polar elastomer such as EPDM and increases the adhesion of peroxide cured elastomers to polyester, aramid or metal substrates.

A substituted phenolic derivative such as 2,6-di-tertiary-butyl-N,N-dimethylamino-P-cresol can be used as a scorch inhibitor for peroxide cured systems. It initially forms an adduct to trap the radical from the peroxide and affects the processing and flow time to the compound.

Above elastomers (NBR and the ethylene polymer) and any other ingredients can be blended by conventional rubber blending methods. In some embodiments, the mixing is generally carried out using an industrial mixer, such as a Banbury mixer, to mix together all raw ingredients; however, other mixing techniques and methods can be used. For example, roll mills and internal mixers can be used. In some embodiments, the individual raw ingredients are added into the mixer in a specific sequence to ensure sufficient incorporation and dispersion of the raw ingredients. In some embodiments, certain raw ingredients can be mixed together prior to being added in sequence into the mix.

Table 1 and Table 2 provide example ingredient ranges for blended compositions according to this disclosure.

TABLE 1

| | | Option #1 | Option #2 |
|---|---|---|---|
| Ingredient | grams | wt.-% | wt.-% |
| Acrylonitrile butadiene rubber | 40-70 | 20-35 | 26-45 |
| (NBR) (Medium ACN) | | | |
| Ethylene propylene diene terpolymer | 30-50 | 15-25 | 19-32 |
| (EPDM) (High ENB) | | | |
| Semi reinforcing black | 5-10 | 2.5-5 | 3-6 |
| Precipitated silica (BET Surface | 15-25 | 7-12 | 10-16 |
| Area - 165 m²/g) | | | |
| Treated silica | 15-25 | 7-12 | 10-16 |
| Di octyl adipate | 0-2 | 0-1 | 0-1 |
| Stearic acid | 0-1 | 0-1 | 0-1 |
| Zinc oxide | 0-5 | 0-2.5 | 0-3 |
| 1,2-dihydro-2,2,4-tri-methylquinoline | 0-2 | 0-1 | 0-1 |
| Alkylated mercaptobenzimidazole & | 0-2 | 0-1 | 0-1 |
| diphenylamine/acetone condensate | | | |
| Zinc dimethacrylate | 0-2 | 0-1 | 0-1 |
| Modified resorcinol | 0-5 | 0-2.5 | 0-3 |
| Liquid modified polybutadiene | 0-3 | 0-1.5 | 0-2 |
| a,a-bis(t-butylperoxy)diisopropyl- | 0-5 | 0-2.5 | 0-3 |
| benzene | | | |
| 2,6-di-tertiary-butyl-N,N- | 0-0.5 | 0-0.25 | 0-1 |
| dimethylamino-P-cresol | | | |

TABLE 2

| Ingredient | grams | wt.-% |
|---|---|---|
| Acrylonitrile butadiene rubber (NBR) | 55-75 | 25-35 |
| (Medium ACN) | | |
| Ethylene Acrylic Rubber (AEM) | 25-45 | 12-20 |
| Semi reinforcing black | 0-10 | 0-5 |
| Precipitated silica (BET Surface | 10-20 | 5-10 |
| Area - 165 m²/g) | | |
| Treated silica | 10-30 | 5-14 |
| Ester-type plasticizer | 0-2 | 0-1 |
| Long chain fatty acid (C15-C20) | 0-2 | 0-1 |
| Metal oxide | 0-5 | 0-2 |
| Polymerized quinoline derivative | 0-2 | 0-1 |
| (antioxidant) | | |
| Alkylated imidazole and diarylamine or | 0-2 | 0-1 |
| ketone (antioxidant) | | |
| Zinc dimethacrylate | 0-5 | 0-2 |
| Modified resorcinol | 0-5 | 0-2 |
| Liquid modified polybutadiene | 0-5 | 0-2 |
| a,a-bis(t-butylperoxy)diisopropyl-benzene | 0-10 | 0-5 |
| 2,6-di-tertiary-butyl-N,N-dimethylamino- | 0-0.5 | 0-0.25 |
| P-cresol | | |

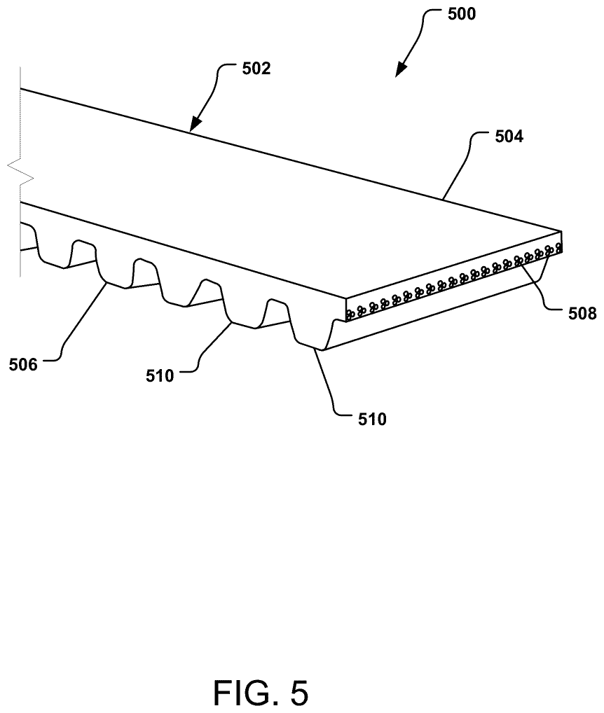

The resulting composition, from Table 1. Table 2, or any described above, can be used to form a belt, such as a synchronous belt. e.g., for automotive uses. FIG. 5 shows a generic belt 500 having a body 502 formed of a flexible material having a back side 504 and a front side 506 with a plurality of load carrying cords 508 within the body 502, the particular cords 508 bound in triplicate bundles although in other embodiments the cords 508 may be single cords or otherwise bundled. The cords 508 may be, e.g., carbon cords, polymeric cords (e.g., polyester, aramid), fiberglass cords, etc. Defined in the front side 506 are a plurality of teeth 510; trapezoidal teeth are depicted in this embodiment of FIG. 5 but the tooth shape is not limited thereto and can take any shape that is compatible with a sprocket, gear or other toothed wheel. Each individual tooth 510 extends perpendicular to the longitudinal length of the belt 500 so that the plurality of teeth 510 run along or around the length of the belt 500. In use, the teeth 510 on the front side 106 are in contact with a drive mechanism, e.g., a toothed gear or sprocket. Although not seen in FIG. 5, the belt 500 is an endless belt, having the form of a loop with no beginning and no end.

### EXAMPLES

Objects and advantages of this disclosure are further illustrated by the following non-limiting examples. The particular materials and amounts thereof recited in these examples as well as other conditions and details, should not be construed to unduly limit this disclosure. Unless otherwise noted, all parts, percentages, ratios, etc. in the Examples and the rest of this disclosure are by weight.

### Example 1

The materials listed in Table 3, at the amounts (in grams) listed, were used to prepare a first blended composition according to this disclosure.

TABLE 3

| Ingredient | grams |
|---|---|
| Acrylonitrile butadiene rubber (NBR) (Medium ACN) | 60 |
| Ethylene propylene diene terpolymer (EPDM) | 40 |
| (High ENB) | |
| Semi reinforcing black | 10 |
| Precipitated silica (BET Surface Area - 165 m²/g) | 20 |
| Treated silica | 20 |
| Di octyl adipate | 2 |
| Stearic acid | 1 |
| Zinc oxide | 5 |
| 1,2-dihydro-2,2,4-tri-methylquinoline | 1.5 |
| Alkylated mercaptobenzimidazole & | 1.5 |
| diphenylamine/acetone condensate | |
| Zinc dimethacrylate | 2 |
| Modified resorcinol | 5 |
| Liquid modified polybutadiene | 3 |
| a,a-bis(t-butylperoxy)diisopropyl-benzene | 5 |
| 2,6-di-tertiary-butyl-N,N-dimethylamino- | 1.05 |
| P-cresol | |

The semi reinforcing black had a specific gravity of 1.8, DBP absorption 30-48 CC/100 g, iodine absorption 6-12 mg/g, maximum heat loss 1%, sieve residue in 325 mesh 0.1%, ash content less than 0.5% and pellet hardness of 30 g.

The precipitated silica had a specific gravity of 2.0 and appeared as a fine white odorless powder. BET surface area of silica was between 130-200 m²/g. Loss on drying (105° C., 2 hrs) was between 3-7%. Loss on ignition, on anhydrous basis (1000° C., 2 hours) was 6% max. The pH of 5% water slurry was in the range of 6-8, SiO2, hydrate % was minimum 87%, DBP absorption value was between 200-280 mL for 100 g.

The treated silica used had a specific gravity of 1.9-2.0. The trialkoxysilane treatment content was between 5-8%. The volatile content in this treated silica was 3-5%, the pH value was between 6-8 and appeared as a white powder. The specific surface area of the silica grade was between 120-150 m2/g.

The zinc oxide was an odorless white colored fine powder with a specific gravity of 5.6 and surface area of 4-6 m2/g. The grade had heat loss value of maximum 0.5% at 110° C. The ash content of the grade was 99%, wet sieve residue (% retained on #325 mesh) was not more than 0.05 and (% retained on #200 mesh) was less than 0.02. Presence of CuO was <0.0005%, MnO<0.0005%, SiO2<0.02% and water soluble salt<0.05%.

Mixing of the ingredients were done in three stages. In the first stage, all materials excluding the curatives were charged in the intermix at an RPM between 10-20. Overall mixing time was between 8-12 minutes to a dump temperature of 150° C. In the second stage, the compound was again mixed to 150° C. for better dispersion and homogeneity. The peroxide curatives were added in the third stage of mixing, where the RPM was kept between 8-10 and the batch was dumped at 95° C.

The mixed stock was cured for 20 minutes at 180° C. using a hydraulic press.

Physical properties of the cured slab were determined with stress-strain tests giving Tensile strength, Modulus, Elongation (ASTM D412), Tear test (ASTM D624), Shore A hardness (ASTM D2240), Volume swell (ASTM D471) in IRM 901 at 135° C. for 168 hours, Compression set (ASTM D395) at 135° C. for 168 hours.

An ozone test was carried out by placing a dumbbell-shaped sample under stretch (20% and 30%) in an ozone chamber containing 50 ppm ozone at 40° C. These samples were investigated at 7× magnification for any crack generation after certain intervals.

Cold flexibility was tested by placing a cured strip of compound (dimension: 6″×1″×0.75″) in a−35° C. cold chamber for 24 hours and then bending the sample at an angle of 180° after the specified conditioning time is over.

Results of above tests are listed in Table 4.

TABLE 4
Mooney Scorch data (tested at 133° C.)

| | | |
|---|---|---|
| Mm | (Mm) | 44 |
| T5 | (min) | 17 |
| T35 | (min) | 26.5 |

Rheometric data (tested at 180° C. for 4 minutes)

| | | |
|---|---|---|
| ML | (lb-in) | 2.02 |
| MH | (lb-in) | 17.0 |
| Ts2 | (sec) | 37 |
| TC90 | (sec) | 188 |

Physical property of slab cured at 180° C. for 20 minutes

| | | |
|---|---|---|
| Tensile Strength | (kg/cm2) | 204.61 |
| Elongation at break | (%) | 429 |
| Modulus | (kg/cm2) | 31.89 |
| Hardness | (Shore A) | 72 |
| Volume swell at 135° C. for | (%) | 17.5 |
| 168 hrs in IRM 901 oil | | |
| Ozone resistance at | | no |
| 40° C./50 ppm ozone | | visible |
| | | cracks |
| Cold flexibility at −35° C. | | ok |

The cured slab of the NBR/EPDM blended compound was used to make a trial synchronous belt on which a series of static test was carried out. Table 5 shows a comparison between a control belt made with existing compound and trial belts made with the NBR/EPDM blended compound of Table 3.

TABLE 5

| | | Control | Trial |
|---|---|---|---|
| Parameters | Unit | Belt | belt |
| Hardness (Back Rubber) | (Shore A) | 78 | 80 |
| Tensile Strength | (kN/mm) | 22.3 | 22.28 |
| Web Adhesion Strength | (N/cm) | 28.7 | 39.47 |
| Tooth Adhesion Strength | (N/cm) | 144 | 252.33 |
| Cord Pull out Strength | (N/2c) | 1050 | 1170 |
| Jacket Shear Strength | (N/cm) | 1350 | 1507 |
| Tooth Shear Strength | (N/cm) | 1510 | 1543 |

The materials listed in Table 6, at the amounts (in grams) listed, were used to prepare another blended composition according to this disclosure.

### Example 2

TABLE 6

| Ingredient | grams |
|---|---|
| Acrylonitrile butadiene rubber (NBR) (Medium ACN) | 70 |
| Ethylene Acrylic rubber (AEM) | 30 |
| Semi reinforcing black | 10 |
| Precipitated silica (BET Surface Area - 165 m²/g) | 20 |
| Treated silica | 20 |
| Ester-type plasticizer | 2 |
| Long chain fatty acid (C15-C20) | 1 |
| Metal oxide | 5 |
| Polymerized quinoline derivative (antioxidant) | 1.5 |
| Alkylated imidazole and diarylamine or ketone (antioxidant) | 1.5 |
| Zinc dimethacrylate | 2 |
| Modified resorcinol | 5 |
| Liquid modified polybutadiene | 3 |
| a,a-bis(t-butylperoxy)diisopropyl-benzene | 5 |
| 2,6-di-tertiary-butyl-N,N-dimethylamino-P-cresol | 1.05 |

The same tests were run on Example 2 as on Example 1, and the results are provided below in Table 7 and Table 8.

TABLE 7
Mooney Scorch data (tested at 133° C.)

| | | |
|---|---|---|
| Mm | (Mm) | 41 |
| T5 | (min) | 14 |
| T35 | (min) | 23.3 |

Rheometric data (tested at 180° C. for 4 minutes)

| | | |
|---|---|---|
| ML | (lb-in) | 1.85 |
| MH | (lb-in) | 16.5 |
| Ts2 | (sec) | 32 |
| TC90 | (sec) | 179 |

Physical property of slab cured at 180° C. for 20 minutes

| | | |
|---|---|---|
| Tensile Strength | (kg/cm2) | 212.22 |
| Elongation at break | (%) | 395 |
| Modulus | (kg/cm2) | 38.7 |
| Hardness | (Shore A) | 75 |
| Volume swell at 135° C. for | (%) | 11.32 |
| 168 hrs in IRM 901 oil | | |
| Ozone resistance at | | no |
| 40° C./50 ppm ozone | | visible |
| | | cracks |
| Cold flexibility at −35° C. | | ok |

TABLE 8

| | | Existing | Trial |
|---|---|---|---|
| Parameters | Unit | Belt | belt |
| Hardness (Back Rubber) | (Shore A) | 78 | 80 |
| Tensile Strength | (kN/mm) | 22.3 | 22.24 |
| Web Adhesion Strength | (N/cm) | 28.7 | 40.1 |
| Tooth Adhesion Strength | (N/cm) | 144 | 246.32 |
| Cord Pull out Strength | (N/2c) | 1050 | 1145 |
| Jacket Shear Strength | (N/cm) | 1350 | 1500 |
| Tooth Shear Strength | (N/cm) | 1510 | 1512 |

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed:

1. A synchronous belt formed from an uncured composition comprising acrylonitrile butadiene rubber (NBR) and ethylene polymer, the NBR and ethylene polymer present as 25 to 75 wt.-% of the uncured composition.

2. A belt formed from the uncured composition of claim 1, wherein the NBR is present as 30 to 60 wt.-% of the uncured composition and the ethylene polymer is present as 10 to 30 wt.-% of the uncured composition.

3. The belt formed from the uncured composition of claim 1, wherein the NBR is 30 to 50 wt.-% of the uncured composition.

4. The belt formed from the uncured composition of claim 1, the uncured composition further comprising organic peroxide.

5. The belt formed from the uncured composition of claim 1, wherein the ethylene polymer is ethylene propylene diene terpolymer (EPDM).

6. The belt formed from the uncured composition of claim 1, wherein the ethylene polymer is an ethylene acrylic elastomer.

7. The belt formed from the uncured composition of claim 1, wherein the ethylene polymer is a chlorinated polyethylene.

8. The belt formed from the uncured composition of claim 1, the uncured composition further comprising carbon reinforcing filler and silica.

9. The belt formed from the uncured composition of claim 8, wherein the silica is present at a level greater than the carbon reinforcing filler.

10. The belt formed from the uncured composition of claim 9, wherein the silica is present at a level of about 10 to 35 wt.-% of the uncured composition and the carbon reinforcing filler is present at a level of about 3 to 8 wt.-%.

11. The belt formed from the uncured composition of claim 9, wherein the silica is present in relation to the carbon reinforcing filler at a ratio of about 4:1.

12. The belt formed from the uncured composition of claim 1, wherein the belt has a tensile strength of 18 MPa or greater.

13. The belt formed from the uncured composition of claim 1, wherein the belt is readily flexible at −35° C.
